(19) United States
(12) Patent Application Publication
(10) Pub. No.: US 2025/0375639 A1
(43) Pub. Date: Dec. 11, 2025

(54) HOSE MANAGER

(71) Applicant: Howe & Howe Inc., Waterboro, ME (US)

(72) Inventors: Michael J. Zagorianakos, Buxton, ME (US); Timothy Merlin Foley, Lyman, ME (US); Jesse Morrill, Standish, ME (US)

(21) Appl. No.: 18/739,935

(22) Filed: Jun. 11, 2024

(51) Int. Cl. A62C 27/00; A62C 33/04

(52) U.S. Cl. CPC A62C 27/00; A62C 33/04

(57) ABSTRACT

A technique is directed to utilizing a hose manager. The hose manager includes a set of vehicle mounts constructed and arranged to mount to a vehicle. The hose manager further includes an elongated section defining a hose deflection surface. The hose manager further includes a set of intermediate sections constructed and arranged to be disposed between the elongated section and the set of vehicle mounts. The set of intermediate sections is further constructed and arranged to laterally position the hose deflection surface at a predefined distance from the vehicle to deflect a hose away from a lower portion of the vehicle while the hose is connected with the vehicle.

### BACKGROUND

Some conventional firefighting equipment extinguishes fires by spraying water. Along these lines, such conventional firefighting equipment receives water from a hose line connected to a water source (e.g., a hydrant).

Some conventional firefighting equipment further has the ability to move across a ground surface. For example, the conventional firefighting equipment may traverse an area adjacent to a burning structure while towing the hose line and, once in position, receive water from the hose line to spray on to the burning structure.

### SUMMARY

Unfortunately, there are deficiencies to the above-described conventional firefighting equipment. Along these lines, operating conventional firefighting equipment that has the ability to move across a ground surface creates a risk of running over the hose lines, entangling the hose lines with the firefighting equipment, etc. To counteract such a risk, one or more firefighters conventionally follow behind the firefighting equipment and reposition the hose lines as needed to prevent the hose lines from becoming entangled. However, following behind the firefighting equipment is dangerous or infeasible in some circumstances, e.g., in high temperature, oxygen-deprived environments, etc. Further, even in environments in which a firefighter is physically able to follow behind the firefighting equipment, some firefighting operations with limited personnel cannot afford to have a dedicated person following the vehicle when other tasks need to be performed elsewhere.

In contrast to the above-described conventional firefighting equipment, improved techniques are directed to a hose manager that deflects a hose from the ground. Along these lines, the hose manager is mounted to a vehicle and provides a deflection surface that supports a hose at a predefined distance from the vehicle. These features enable the vehicle to perform corrective movements (e.g., backing up and/or turning) without the risk of running over the hose.

One embodiment is directed to a vehicle. The vehicle includes a set of ground-engaging members. The vehicle further includes a vehicle body supported by the set of ground-engaging members. The vehicle further includes a hose manager, including:
(A) a set of vehicle mounts constructed and arranged to mount to the vehicle body;
(B) an elongated section defining a hose deflection surface; and
(C) a set of intermediate sections constructed and arranged to be disposed between the elongated section and the set of vehicle mounts, the set of intermediate sections being further constructed and arranged to laterally position the hose deflection surface at a predefined distance from the vehicle body to deflect a hose away from the set of ground-engaging members while the hose is connected with the vehicle body.

Another embodiment is directed to a hose manager. The hose manager includes a set of vehicle mounts constructed and arranged to mount to a vehicle. The hose manager further includes an elongated section defining a hose deflection surface. The hose manager further includes a set of intermediate sections constructed and arranged to be disposed between the elongated section and the set of vehicle mounts. The set of intermediate sections is further constructed and arranged to laterally position the hose deflection surface at a predefined distance from the vehicle to deflect a hose away from a lower portion of the vehicle while the hose is connected with the vehicle.

Yet another embodiment is directed to a method of installing a hose manager on a vehicle. The method includes mounting a set of vehicle mounts to the vehicle. The method further includes, after mounting the set of vehicle mounts to the vehicle, disposing a set of intermediate sections between an elongated section and the set of vehicle mounts. The elongated section defines a hose deflection surface. The set of intermediate sections laterally position the hose deflection surface at a predefined distance from the vehicle to deflect a hose away from a lower portion of the vehicle while the hose is connected with the vehicle. The method further includes coupling the set of intermediate sections and the set of vehicle mounts to maintain the hose deflection surface at the predefined distance from the vehicle.

In some arrangements, the set of vehicle mounts defines a set of mounting interfaces constructed and arranged to removably engage the set of intermediate sections. Additionally, the hose manager further includes a locking mechanism constructed and arranged to selectively couple the set of intermediate sections and the set of vehicle mounts while the set of mounting interfaces engages the set of intermediate sections.

In some arrangements, the set of intermediate sections includes a plurality of side sections constructed and arranged to laterally extend from the elongated section to form a U-shaped add-on. The plurality of side sections defines a respective plurality of end portions of the U-shaped add-on. The plurality of end portions is constructed and arranged to removably engage the set of vehicle mounts.

In some arrangements, the set of vehicle mounts includes a plurality of brackets constructed and arranged to couple with the vehicle. The plurality of brackets defines a plurality of mounting interfaces constructed and arranged to receive the plurality of end portions of the U-shaped add-on.

In some arrangements, the set of intermediate sections further includes a middle section constructed and arranged to laterally extend from the elongated section between a first side section and a second side section of the plurality of side sections. Additionally, the hose manager further includes:
(A) a first gusset segment constructed and arranged to connect to the elongated section, the first side section, and the middle section; and
(B) a second gusset segment constructed and arranged to connect to the elongated section, the second side section, and the middle section, the first gusset segment and the second gusset segment providing torsional resistance to the middle section.

In some arrangements, the plurality of side sections is further constructed and arranged to be disposed between two ground-engaging members of the set of ground-engaging members to avoid debris thrown from the set of ground-engaging members while the vehicle is moving.

In some arrangements, the vehicle body includes a hose connection port that connects with the hose to provide fluid transfer. Additionally, the set of intermediate sections is further constructed and arranged to position the hose deflection surface to be lower than the hose connection port to support a bottom of the hose while the hose is connected with the hose connection port.

In some arrangements, the set of vehicle mounts includes an adaptor defining a first mounting interface constructed and arranged to be inserted into a receiver defined by the vehicle body. The adapter further defines a second mounting interface constructed and arranged to removably engage with at least one intermediate section in the set of intermediate sections.

In some arrangements, the adaptor is constructed and arranged to couple with a cable winch to provide towing capabilities to the vehicle.

In some arrangements, the receiver defined by the vehicle body is disposed at a first height. Additionally, the adaptor is constructed and arranged to position the second mounting interface at a second height that is different from the first height when the first mounting interface is inserted into the receiver.

This Summary is provided merely for purposes of summarizing some example embodiments so as to provide a basic understanding of some aspects of the disclosure. Accordingly, it will be appreciated that the above-described example embodiments are merely examples and should not be construed to narrow the scope or spirit of the disclosure in any way. Other embodiments, aspects, and advantages will become apparent from the following detailed description taken in conjunction with the accompanying drawings which illustrate, by way of example, the principles of the described embodiments.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1a through 1c show different views of an example vehicle in accordance with certain embodiments.

FIGS. 2a and 2b show example features of a hose manager in accordance with certain embodiments.

FIGS. 3a and 3b show example features of a hose manager in accordance with certain embodiments.

FIG. 4 shows example features of a hose manager in accordance with certain embodiments.

FIG. 5 shows a flowchart of an installation operation in accordance with certain embodiments.

### DETAILED DESCRIPTION

An improved technique is directed to a hose manager that deflects a hose from the ground. Along these lines, the hose manager is mounted to a vehicle and provides a hose deflection surface to support a hose at a predefined distance from the vehicle. These features enable the vehicle to perform corrective movements (e.g., backing up and/or turning) without the risk of running over the hose.

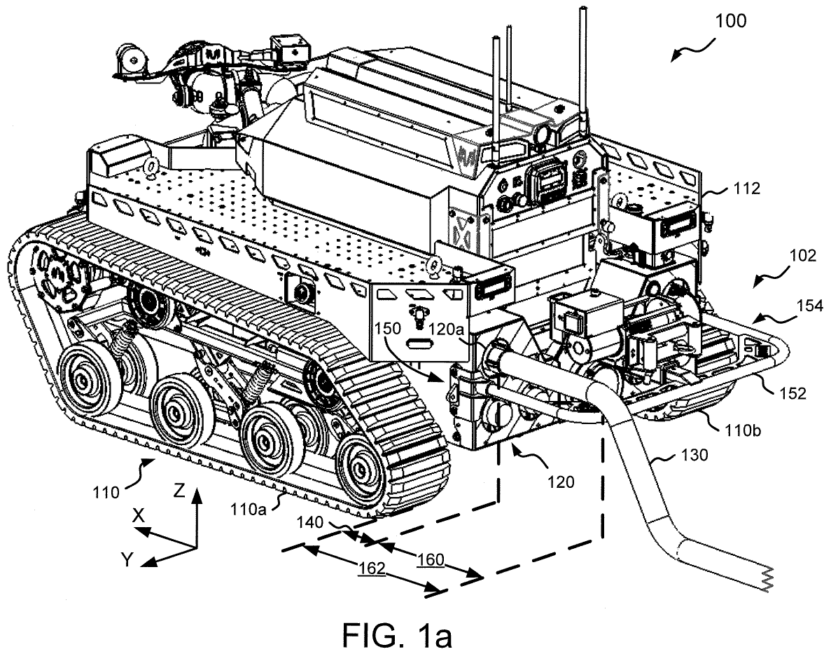

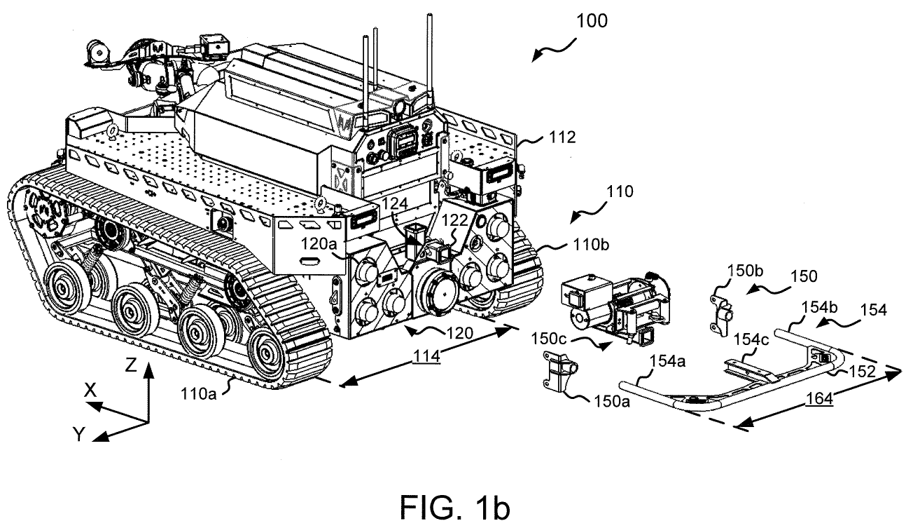

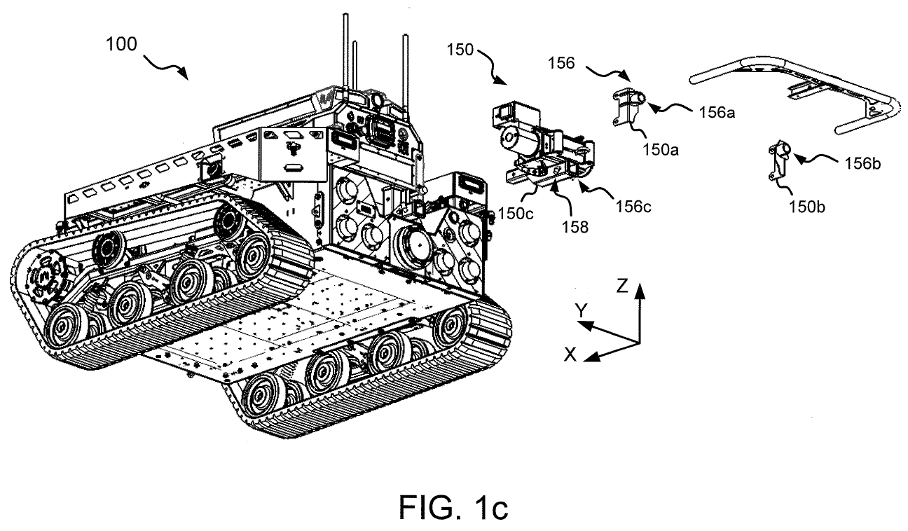

FIGS. 1a through 1c show different views of a vehicle 100 having a hose manager 102 in accordance with certain embodiments. FIG. 1a shows a perspective view of the vehicle 100 coupled with the hose manager 102. FIGS. 1b and 1c show exploded views of the vehicle 100 and the hose manager 102.

In some embodiments, the vehicle 100 is a remote-controlled firefighting vehicle that provides fire suppression, surveillance, intelligence gathering, combinations thereof, etc. It should be understood that other types of vehicles are suitable for use as well, such as trailers, vans, buses, campers, flying vehicles, water vehicles, and so on.

As shown, the vehicle 100 includes ground-engaging member 110a, 110b (collectively, ground-engaging members 110) and a vehicle body 112.

The ground-engaging members 110 are constructed and arranged to move the vehicle 100 upon receiving drive, e.g., from a motor, an engine, combinations thereof, etc. As shown in FIG. 1a, the ground-engaging members 110a and 110b are separated by a distance 114 in a transverse direction (e.g., along the Y-axis).

In some embodiments, the ground-engaging members 110 include a set of continuous tracks. Other example ground-engaging members include wheels, tires, combinations thereof, etc.

The vehicle body 112 is supported by the ground-engaging members 112, includes hose connection ports 120, and defines a receiver 122. In some embodiments, the vehicle body 112 further includes structural framing, a set of walls and a roof, railings, combinations thereof, and so on.

The hose connection ports 120 are constructed and arranged to connect hoses with the vehicle 100. As shown in FIG. 1a, a hose 130 is connected with a particular hose connection port 120a on a rear side of the vehicle body 112. In some embodiments, the hose connection ports 120 are constructed and arranged to provide secure connections between hoses and the vehicle body 112 to enable the vehicle 100 to tow the hoses when the vehicle 100 moves.

In some embodiments, the hose connection ports 120 are further constructed and arranged to provide fluid transfer between the vehicle 100 and the hoses. Along these lines, in some embodiments, the vehicle 100 receives water through the hose 130 from a water source (e.g., a hydrant) and releases the water to suppress fires. However, it should be understood the hose connection ports 120 are provided for example purposes, and in some embodiments, other types of umbilical lines (hoses) are suitable for use as well, such as hydraulic/pneumatic fluid lines, fuel lines, oxygen tubes, electrical cables, tethers, etc.

As further shown in FIG. 1a, the hose connection ports 120 are disposed a distance 140 from the ground-engaging members 112 in a longitudinal (or horizontal) direction (e.g., along the X-axis). It should be appreciated that, in conventional firefighting equipment without the hose manager 102, the distance between the equipment and hose lines creates a significant risk of hose lines being run over or entangled with the ground-engaging members when the conventional firefighting equipment moves.

The receiver 122 is a mounting interface constructed and arranged to receive an attachment (e.g., a trailer, a peripheral device, etc.) to couple with the vehicle body 112. In some embodiments, the receiver 122 includes a locking mechanism 124 (e.g., a locking pin) constructed and arranged to hold the attachment in place when inserted into the receiver 122. In some embodiments, the receiver 122 is a 2-inch hitch receiver.

The hose manager 102 includes vehicle mounts 150a, 150b, 150c (collectively, vehicle mounts 150), an elongated section 152, and intermediate sections 154a, 154b, 154c (collectively, intermediate sections 154).

The vehicle mounts 150 are constructed and arranged to mount the hose manager 102 to the vehicle body 112. In some embodiments, the vehicle mounts 150 are coupled with the vehicle body 112 using removable mounting hardware (e.g., threaded bolts, threaded nuts, washers, combinations thereof, etc.).

As best shown in FIG. 1c, the vehicle mounts 150a, 150b, and 150c define respective mounting interfaces 156a, 156b, and 156c (collectively, mounting interfaces 156). The mounting interfaces 156 are constructed and arranged to removably engage respective intermediate sections 154. Additionally, as shown, the vehicle mount 150c includes a locking mechanism 158 (e.g., a locking pin). In some embodiments, the locking mechanism 158 is constructed and arranged to selectively couple the intermediate sections 154 and the vehicle mounts 150 while the mounting interfaces 156 engage the intermediate sections 154.

Characteristics of vehicle mounts 150 (e.g., a number of connection points, distances between holes, the size of the mounting hardware, combinations thereof) may be adjusted based on the required strength. Such parameters may be based on the amount of weight of the hose manager 102 and the amount of weight expected to be carried by the hose manager 102, among other things.

The elongated section 152 defines a hose deflection surface to deflect a hose away from the ground. In some embodiments, the hose deflection surface is a top face of elongated section 152. As shown in FIG. 1a, a portion of the hose 130 rests atop the hose deflection surface. In this manner, the hose 130 is held away from the ground-engaging members 112 of the vehicle 100, enabling the vehicle 100 to perform corrective maneuvers without risk of running over the hose 130.

The intermediate sections 154 are constructed and arranged to be disposed between the elongated section 152 and the vehicle mounts 150. In some embodiments, the intermediate sections 154 are further constructed and arranged to laterally position the hose deflection surface at a predefined distance 160 away from the vehicle body to deflect the hose away the set of ground-engaging members while the hose is connected with the vehicle body. As shown, the distance 160 is measured in a longitudinal direction (e.g., along the X-axis) relative to the vehicle 100.

It should be appreciated that hose manager 102 provides an increase in the distance between the hose 130 and the ground-engaging members 110. Along these lines, the hose manager 102 positions the hose 130 at a total distance 162 from the ground-engaging members 110 in the longitudinal direction, rather than merely the distance 140 between the hose connection port 120a and the ground-engaging members 110. In this manner, the vehicle 100 is capable of making corrective maneuvers (e.g., turning, backing up, combinations thereof, etc.) without running over the hose 130.

As best shown in FIG. 1a, in some embodiments, the intermediate sections 154 are further constructed and arranged to position the hose deflection surface to be lower than one or more of the hose connection ports 120 (e.g., the hose connection port 120a). In this manner, the hose deflection surface supports a bottom of the hose 130 while the hose 130 is connected with the hose connection port 120a.

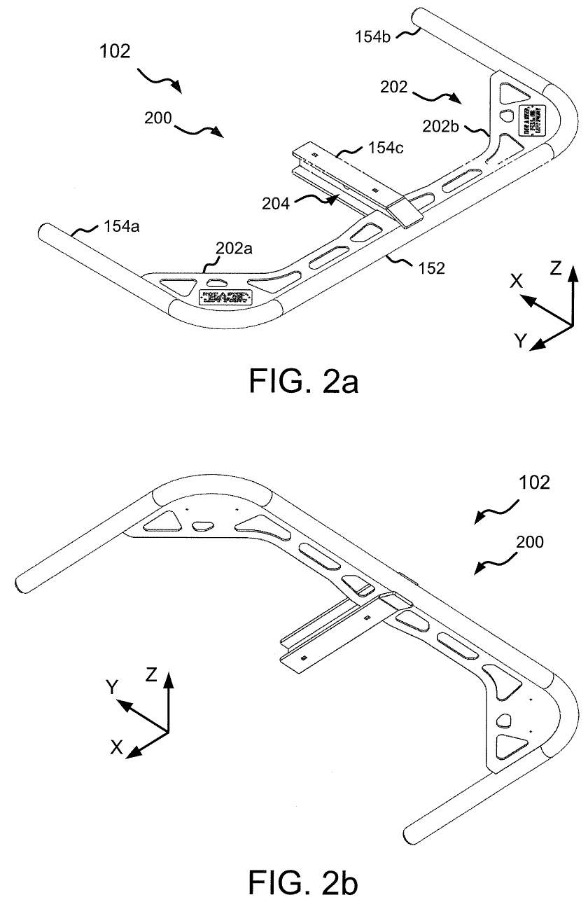

As best shown in FIG. 1b, in some embodiments, when the hose manager 102 is mounted to the vehicle 100, the intermediate sections 154 are disposed between the ground-engaging members 110a and 110b. That is, the intermediate sections 154 are constructed and arranged to span a width 164 in the transverse direction (e.g., along the Y-axis). As shown, the width 164 is less than distance 114 between the ground-engaging members 110a and 110b. In this manner, the hose manager 102 avoids debris is thrown from the ground-engaging members 110 while the vehicle is moving. Further details will now be provided with reference to FIGS. 2a and 2b.

FIGS. 2a and 2b show various perspective views of the hose manager 102 in accordance with certain embodiments. For simplicity, some features of the hose manager 102 (e.g., the vehicle mounts 150) are not shown.

In some embodiments, the elongated section 152 and one or more of the intermediate sections 154 form a U-shaped add-on 200 to the vehicle 100 (FIG. 1). In some embodiments, the U-shaped add-on 200 is constructed from stainless steel and/or other rust-resistant materials.

In some embodiments, one or more portions of the U-shaped add-on 200 are formed from a single, continuous member (e.g., a hollow, metal tube). Along these lines, as shown, the intermediate sections 154a and 154b extend from the elongated section 152 to form two side sections of the U-shaped add-on 200. In some embodiments, the side sections define respective end portions of the U-shaped add-on 200. As will be discussed in greater detail below, in some embodiments, the end portions are constructed and arranged to removable engage the vehicle mounts 150.

Characteristics of U-shaped add-on 200 (e.g., a number of connection points, distances between particular sections, the size of particular sections, combinations thereof) may be adjusted based on the required strength. Such parameters may be based on the amount of weight of the hose manager 102 and the amount of weight expected to be carried by the hose manager 102, among other things.

As shown, the middle intermediate section 154c is coupled with a central portion of the elongated section 152 disposed between the other intermediate sections 154a and 154b. In some embodiments, the middle intermediate section 154c is provided as an I-beam extending from the elongated section 152.

In some embodiments, the middle intermediate section 154c defines a locking interface 204. In some embodiments, the locking mechanism 158 (FIG. 1c) of the vehicle mount 150c is constructed and arranged to engage (be inserted into) the locking interface 204 to selectively couple the intermediate sections 154 and the vehicle mounts 150.

In some embodiments, the middle intermediate section 154c is welded to the elongated section 152. Other types of couplings are suitable for use as well, such as bolts, rivets, and so on.

In some embodiments, the intermediate sections 154 extend parallel to each other, e.g., along respective axes parallel to the X-axis. In this manner, when the hose manager 102 is coupled with the vehicle body 112, the intermediate sections 154 laterally extend between the vehicle mounts 150 and the elongated section 152.

In some embodiments, the hose manager 102 further includes gusset segments 202a, 202b (collectively, gusset segments 202). As shown, the gusset segment 202a is connected to the elongated section 152, the side intermediate section 154a, and the middle intermediate section 154c. As further shown, the gusset segment 202b is connected to the elongated section 152, the side intermediate section 154b, and the middle intermediate section 154c.

The gusset segments 202 may be different portions of a single member (e.g., a single gusset spanning the elongated section 152 and the intermediate sections 154) or multiple members (e.g., a first gusset and a second gusset).

In some embodiments, the gusset segments 202 provide increased structural integrity to the U-shaped add-on 200. Along these lines, in some embodiments, the gusset segments 202 provide torsional resistance to the middle intermediate section 154c (e.g., to constrain the middle intermediate section 154c from rotating about the X-axis). In some embodiments, the gusset segments 202 provide additional support to the U-shaped add-on 200, e.g., to reduce bending or other deformation of the elongated section 152 and/or the intermediate sections 154.

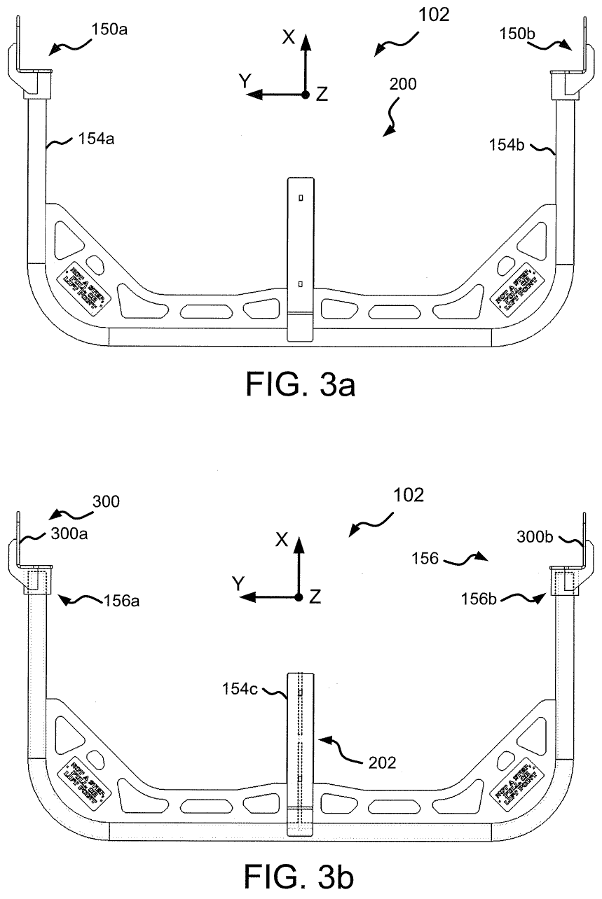

In some embodiments, the gusset segments 202 are welded to the elongated section 152 and intermediate sections 154. Other types of couplings are suitable for use as well, such as bolts, rivets, and so on. Further details will now be provided with reference to FIGS. 3a and 3b.

FIGS. 3a and 3b show additional features of the hose manager 102 in accordance with certain embodiments. FIG. 3a shows a top-down view of the hose manager 102. FIG. 3b shows a cross-sectional view of the hose manager 102. As shown, the hose-manager includes the U-shaped add-on 200 coupled with the vehicle mounts 150a and 150b.

The vehicle mounts 150 are constructed and arranged to mount to the vehicle 100 (FIG. 1). Along these lines, as shown, the vehicle mounts 150a and 150b include respective brackets 300a and 300b (collectively, brackets 300). In some embodiments, the brackets 300 are L-shaped.

In some embodiments, the brackets 300 are coupled with the elongated section 152 using removable mounting hardware (e.g., threaded bolts, threaded nuts, washers, combinations thereof, etc.). However, other types of couplings are suitable for use as well, such as welds, rivets, and so on.

In some embodiments, the brackets 300a and 300b define the respective mounting interfaces 156a and 156b (FIG. 1c), which receive the end portions of the U-shaped add-on 200. In some embodiments, the mounting interfaces 156a and 156b are constructed and arranged to restrain movement of the U-shaped add-on 200 (e.g., about the X-axis and/or other axes).

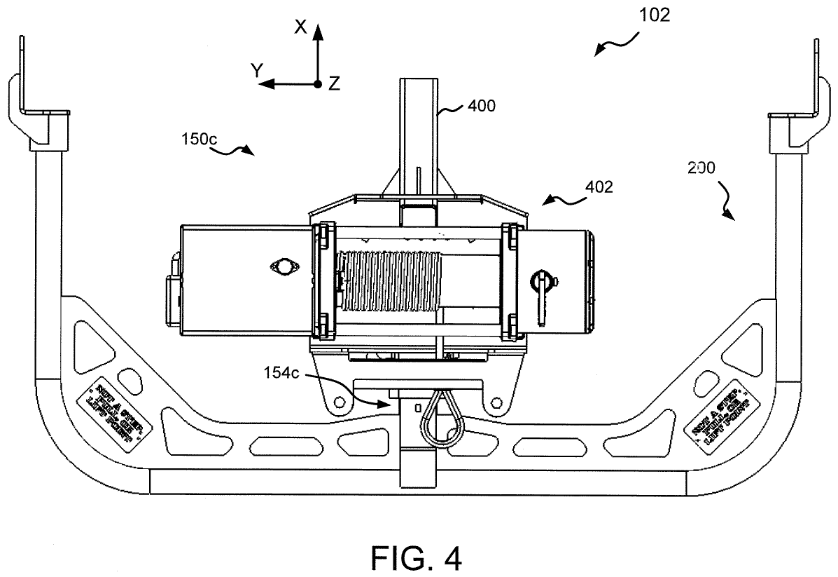

In some embodiments, after engaging the mounting interfaces 156, the U-shaped add-on 200 is maintained in place by engaging the locking mechanism 158 (FIG. 1c) of the middle vehicle mount 150c. Advantageously, the locking mechanism 158 simplifies manufacture, installation, and removal of the hose manager 102, as no additional locking mechanisms are needed to connect the U-shaped add-on 200 with the vehicle mounts 150. That is, when the U-shaped add-on is inserted into the vehicle mounts 150 and the locking mechanism 158 is engaged, the side sections of the U-shaped add-on 200 are held in place in the mounting interfaces 156a and 156b. Further details will now be provided with reference to FIG. 4.

FIG. 4 shows additional features of the hose manager 102 in accordance with certain embodiments. As shown, the middle intermediate member 154c is coupled with the middle vehicle mount 150c.

In addition to the mounting interface 156c (FIG. 1c) constructed and arranged to engage the intermediate member 154c, the middle vehicle mount 150c further includes another mounting interface 400 (e.g., a 2-inch hitch attachment). In some embodiments, the mounting interface 400 is constructed and arranged to be inserted into the receiver 122 defined by the vehicle body 112 (FIG. 1b). That is, the vehicle mount 150c serves as an adaptor between the receiver 122 and the intermediate section 154c. In some embodiments, the vehicle mount 150c is maintained in place by engaging the locking mechanism 124 (FIG. 1b) on the receiver 122 when the mounting interface 400 is inserted into the receiver 122.

In some embodiments, the adaptor is constructed and arranged to couple with other devices to provide additional capabilities to the vehicle 100. Along these lines, as shown, the adaptor is coupled with a cable winch 402 to provide towing capabilities to the vehicle. Advantageously, coupling these devices to the adaptor (or more generally, the hose manager 102) provide efficient space utilization.

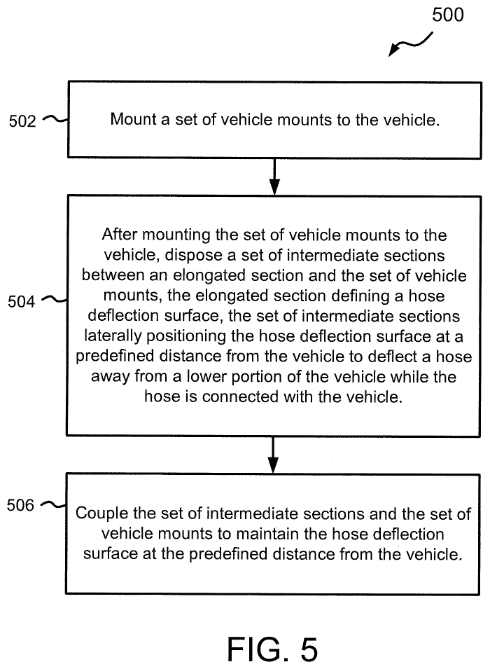

In some embodiments, the adaptor positions the mounting interface 156c at a different height than the receiver 122. For example, as best shown in FIG. 1a, when the mounting interface 400 is inserted into the receiver 122, the receiver 122 is disposed at a first height and the mounting interface 156c is disposed at a second height that is different than the first height. In some embodiments, the second height is lower than the first height, e.g., to position the hose deflection surface of the hose manager 102 to be lower than one or more of the hose connection ports 120 on the vehicle body 112. In this manner, the hose deflection surface provides support to an underside of a hose (e.g., the hose 130) while the hose is connected with the vehicle 100. Further details will now be provided with reference to FIG. 5.

FIG. 5 shows a procedure 500 to install the hose manager 102 on the vehicle 100 in accordance with certain embodiments.

At 502, vehicle mounts 150 are mounted to the vehicle body 112. In some embodiments, the vehicle mounts 150 are mounted to the vehicle body 112 using removable mounting hardware (e.g., threaded bolts, threaded nuts, washers, combinations thereof, etc.).

At 504, after mounting the vehicle mounts 150 to the vehicle body 112, the intermediate sections 154 are disposed between the elongated section 152 and the vehicle mounts 150. As discussed above, the elongated section 152 defines a hose deflection surface. It should be understood that, when the intermediate sections 154 are disposed between the elongated section 152 and the vehicle mounts 150, the intermediate sections 154 laterally position the hose deflection surface at a predefined distance 160 from the vehicle body 112 (FIG. 1a). In this manner, the hose deflection surface deflects a hose away from a lower portion of the vehicle 100 (e.g., the ground-engaging members 110) while the hose is connected with the vehicle 100.

At 506, the intermediate sections 154 are coupled with the vehicle mounts 150 to maintain the hose deflection surface at the predefined distance 160 from the vehicle body 112. Along these lines, in some embodiments, the locking mechanism 158 is coupled with the middle intermediate section 154c and vehicle mount 150c while the set of mounting interfaces engages the set of intermediate sections to maintain the hose deflection surface at the predefined distance 160 from the vehicle body 112.

As described above, an improved technique is directed to a hose manager that deflects a hose from the ground. Along these lines, the hose manager is mounted to a vehicle and provides a deflection surface that supports a hose at a predefined distance from the vehicle. These features enable the vehicle to perform corrective movements (e.g., backing up and/or turning) without the risk of running over the hose.

While various embodiments of the present disclosure have been particularly shown and described, it will be understood by those skilled in the art that various changes in form and details may be made therein without departing from the spirit and scope of the present disclosure as defined by the appended claims.

For example, in some embodiments described above, the cable winch 402 is coupled with the vehicle mount 150c to provide towing capabilities to the vehicle 100. It should be appreciated that, in some embodiments, other devices (e.g., a hose storage rack, a basket, combinations thereof, etc.) may be installed instead of or in addition to the cable winch 402 to provide additional capabilities to the vehicle 100. Further, these devices may be coupled with other locations of the hose manager 102 and/or vehicle 100, (e.g., the elongated section 152, one or more of the intermediate sections 154, combinations thereof, etc.).

Further, in some embodiments, the hose manager 102 includes one or more additional hose deflection surfaces to deflect a hose. For example, in some embodiments, the hose manager 102 includes one or more surfaces to restrain the hose 130 from moving side-to-side (e.g., along the Y-axis) or vertically (e.g., along the Z-axis).

A conventional remote-controlled vehicle allows the user to drive places that are not safe or convenient for a person. But with hoses attached to the conventional remote-controlled vehicle, it can be hard to maneuver and not get them caught in the tracks or snagged on the vehicle. In contrast, techniques disclosed herein help to hold the hose out of the way to allow for some maneuvers to be made with hoses still attached.

Some embodiments include a stainless-steel hoop that allows for the water hoses attached to the vehicle inlets to rest on and hold out further from the vehicle. In some embodiments, end points bolted on vehicle sides accept the hoop ends to support the bar, with no pin or locking mechanism required on the hoop ends. Just slide the center bar into the receiver, line up the outer ends, and install the pin on the center receiver under the winch.

Some embodiments provide a modular hose management system that includes a hoop that is installed onto the rear of the vehicle and acts as a guide for hoses to rest on when moving the vehicle around. Conventionally, when the hoses are not charged with water and are loose, backing up or turning the vehicle can be a challenge since the hoses can get caught in the tracks. In contrast, some embodiments allow the user to make small corrective movements to the vehicle before moving forward again.

Without this attachment, the user runs the risk of running over a hose if they back up the vehicle and are not paying attention to the placement of the hoses or they are limited on movement as to not run over the hoses. Some embodiments make its less likely when making small corrective maneuvers to the vehicle and allows the user to focus efforts elsewhere.

Some embodiments have a tubular hoop that wraps around the back of the vehicle to create a U-shape. In the center of the hoop, there is a structure that mates with a receiver (e.g., a 2-inch receiver hitch) and is fixed using a pin. The ends of the U-shaped hoop are retained in mounts on the vehicle to help support the hoop. In some embodiments, there are gussets along the inside of the hoop to further strengthen the weldment.

It should be appreciated that conventional hose management is done by firefighters walking around with the robot to ensure that the hose does not get caught in the vehicle or get run over. This requires one or more persons to be with the robot and to stay alert to prevent this from happening.

Some embodiments are implemented on a vehicle or moveable body (cart, dolly) that has any type of umbilical like a water, air, fuel, hydraulic hose/line, or any electrical cable or tether. Any of these examples that move around and run the risk of running over their umbilicals could potentially utilize this invention.

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document. Such modifications and enhancements are intended to belong to various embodiments of the disclosure.

What is claimed is:

1. A vehicle, comprising:
a set of ground-engaging members;
a vehicle body supported by the set of ground-engaging members; and
a hose manager, including:
a set of vehicle mounts constructed and arranged to mount to the vehicle body;
an elongated section defining a hose deflection surface; and
a set of intermediate sections constructed and arranged to be disposed between the elongated section and the set of vehicle mounts, the set of intermediate sections being further constructed and arranged to laterally position the hose deflection surface at a predefined distance from the vehicle body to deflect a hose away from the set of ground-engaging members while the hose is connected with the vehicle body.

2. The vehicle of claim 1 wherein the set of vehicle mounts defines a set of mounting interfaces constructed and arranged to removably engage the set of intermediate sections; and
wherein the hose manager further includes:
a locking mechanism constructed and arranged to selectively couple the set of intermediate sections and the set of vehicle mounts while the set of mounting interfaces engages the set of intermediate sections.

3. The vehicle of claim 1 wherein the set of intermediate sections includes:
a plurality of side sections constructed and arranged to laterally extend from the elongated section to form a U-shaped add-on, the plurality of side sections defining a respective plurality of end portions of the U-shaped add-on, the plurality of end portions being constructed and arranged to removably engage the set of vehicle mounts.

4. The vehicle of claim 3 wherein the set of vehicle mounts includes:
a plurality of brackets constructed and arranged to couple with the vehicle, the plurality of brackets defining a plurality of mounting interfaces constructed and arranged to receive the plurality of end portions of the U-shaped add-on.

5. The vehicle of claim 3 wherein the set of intermediate sections further includes a middle section constructed and arranged to laterally extend from the elongated section between a first side section and a second side section of the plurality of side sections; and
wherein the hose manager further includes:
a first gusset segment constructed and arranged to connect to the elongated section, the first side section, and the middle section; and
a second gusset segment constructed and arranged to connect to the elongated section, the second side section, and the middle section, the first gusset segment and the second gusset segment providing torsional resistance to the middle section.

6. The vehicle of claim 3 wherein the plurality of side sections is further constructed and arranged to be disposed between two ground-engaging members of the set of ground-engaging members to avoid debris thrown from the set of ground-engaging members while the vehicle is moving.

7. The vehicle of claim 1 wherein the vehicle body includes a hose connection port that connects with the hose to provide fluid transfer; and
wherein the set of intermediate sections is further constructed and arranged to position the hose deflection surface to be lower than the hose connection port to support a bottom of the hose while the hose is connected with the hose connection port.

8. The vehicle of claim 1 wherein the set of vehicle mounts includes:
an adaptor defining a first mounting interface constructed and arranged to be inserted into a receiver defined by the vehicle body, the adapter further defining a second mounting interface constructed and arranged to removably engage with at least one intermediate section in the set of intermediate sections.

9. The vehicle of claim 8 wherein the adaptor is constructed and arranged to couple with a cable winch to provide towing capabilities to the vehicle.

10. The vehicle of claim 8 wherein the receiver defined by the vehicle body is disposed at a first height; and
wherein the adaptor is constructed and arranged to position the second mounting interface at a second height that is different from the first height when the first mounting interface is inserted into the receiver.

11. A hose manager, comprising:
a set of vehicle mounts constructed and arranged to mount to a vehicle;
an elongated section defining a hose deflection surface; and
a set of intermediate sections constructed and arranged to be disposed between the elongated section and the set of vehicle mounts, the set of intermediate sections being further constructed and arranged to laterally position the hose deflection surface at a predefined distance from the vehicle to deflect a hose away from a lower portion of the vehicle while the hose is connected with the vehicle.

12. The hose manager of claim 11 wherein the set of vehicle mounts defines a set of mounting interfaces constructed and arranged to removably engage the set of intermediate sections; and
wherein the hose manager further comprises:
a locking mechanism constructed and arranged to selectively couple the set of intermediate sections and the set of vehicle mounts while the set of mounting interfaces engages the set of intermediate sections.

13. The hose manager of claim 11 wherein the set of intermediate sections includes:
a plurality of side sections constructed and arranged to laterally extend from the elongated section to form a U-shaped add-on, the plurality of side sections defining a respective plurality of end portions of the U-shaped add-on, the plurality of end portions being constructed and arranged to removably engage the set of vehicle mounts.

14. The hose manager of claim 13 wherein the set of vehicle mounts includes:
a plurality of brackets constructed and arranged to couple with the vehicle, the plurality of brackets defining a plurality of mounting interfaces constructed and arranged to receive the plurality of end portions of the U-shaped add-on.

15. The hose manager of claim 13 wherein the set of intermediate sections further includes a middle section constructed and arranged to laterally extend from the elongated section between a first side section and a second side section of the plurality of side sections; and
wherein the hose manager further includes:
a first gusset segment constructed and arranged to connect to the elongated section, the first side section, and the middle section; and
a second gusset segment constructed and arranged to connect to the elongated section, the second side section, and the middle section, the first gusset segment and the second gusset segment providing torsional resistance to the middle section.

16. The hose manager of claim 11 wherein the set of vehicle mounts includes:
an adaptor defining a first mounting interface constructed and arranged to be inserted into a receiver defined by the vehicle, the adapter further defining a second mounting interface constructed and arranged to removably engage with at least one intermediate section in the set of intermediate sections.

17. The hose manager of claim 16 wherein the adaptor is constructed and arranged to couple with a cable winch to provide towing capabilities to the vehicle.

18. A method of installing a hose manager on a vehicle, the method comprising:
mounting a set of vehicle mounts to the vehicle;
after mounting the set of vehicle mounts to the vehicle, disposing a set of intermediate sections between an elongated section and the set of vehicle mounts, the elongated section defining a hose deflection surface, the set of intermediate sections laterally positioning the hose deflection surface at a predefined distance from the vehicle to deflect a hose away from a lower portion of the vehicle while the hose is connected with the vehicle; and
coupling the set of intermediate sections and the set of vehicle mounts to maintain the hose deflection surface at the predefined distance from the vehicle.
